(19) United States
(12) Patent Application Publication
(10) Pub. No.: US 2017/0230368 A1
(43) Pub. Date: Aug. 10, 2017

(54) SYSTEM AND METHOD OF LOGGING INTO A WEB SERVER

(71) Applicants: Tahir Khan, Ashburn, VA (US); Nic Devazeille, Leesburg, VA (US)

(72) Inventors: Tahir Khan, Ashburn, VA (US); Nic Devazeille, Leesburg, VA (US)

(21) Appl. No.: 15/483,663

(22) Filed: Apr. 10, 2017

Related U.S. Application Data
(60) Provisional application No. 62/293,439, filed on Feb. 10, 2016.

(51) Int. Cl. H04L 29/06

(52) U.S. Cl. CPC H04L 63/0884; H04L 63/0853; H04L 63/0861; H04L 63/101; G06F 21/313

(57) ABSTRACT

A system and method of logging into an information system without the use of a password. The information system first registers with a verification server. A user may then register with the verification server and create a unique identifier. When the user attempts to sign into the information system, the user may submit their unique identifier to the information system using a computer. The information system then transmits the unique identifier to the verification server to authenticate the user. The verification server then transmits a confirmation request to the user to verify the user requested the login. The user may then send an affirmative message to the verification server which in turn notifies the information system. The information system then logs the user in without the use of a password.

### CROSS-REFERENCE TO RELATED APPLICATION

This application claims the benefit of priority of U.S. provisional application No. 62/293,439, filed Feb. 10, 2016, the contents of which are herein incorporated by reference.

### BACKGROUND OF THE INVENTION

The present invention relates to a system and method of logging into web servers and, more particularly, to a system and method of logging into web servers without the use of passwords.

Currently, to sign into web server, users are prompted to enter their username and password as well as additional second factor authentication methods. Users may be members of multiple services that have websites that require the user to enter a username and password. Users are encouraged to diversify their passwords and use complex combinations of numbers, capital letters and symbols when creating their passwords. Therefore, users are subject to forget their passwords, creating an obvious dilemma.

As can be seen, there is a need for a system and method of logging into web servers without the use of passwords.

### SUMMARY OF THE INVENTION

In one aspect of the present invention, a method of logging into an information system, the steps comprises: receiving information system data at a verification server from the information system, wherein the verification server comprises a processor and a memory that stores the information system data; receiving user data at the verification server, the user data comprising at least a unique identifier and a communication address, wherein the memory stores the user data; and receiving a login request at the information system from the user by the user submitting the unique identifier to the information system, wherein the information system transmits the information system data and the unique identifier submitted by the user to the verification server, wherein the processor of the verification server compares the information system data and the unique identifier sent from the information system with the information system data and the unique data stored on the memory, transmits a confirmation request to the communication address of the user to confirm the login request if the unique identifier and the information system data sent from the information system matches the unique identifier and the information system data stored on the memory, and transmits a login confirmation to the information system when the user affirms the confirmation request, wherein the information system grants the login request to the user when the information system receives the login confirmation from the verification server.

In another aspect of the present invention, a method of logging into an information system, the steps comprises: providing a login application to a user for installing on a remote computer; receiving information system data at a verification server from the information system, wherein the verification server comprises a processor and a memory that stores the information system data; receiving user data at the verification server, the user data comprising at least a unique identifier and a communication address of the remote computer, wherein the memory stores the user data; and receiving a login request at the information system from the user by the user submitting the unique identifier to the information system, wherein the information system transmits the information system data and the unique identifier of the user to the verification server, wherein the processor of the verification server

compares the unique identifier and the information system data sent from the information system with the unique identifier and the information system data stored in the memory, transmits a confirmation request to the remote computer of the user to confirm the login request if the unique identifier and the information system data sent from the information system matches the unique identifier and the information system data stored in the memory, wherein the confirmation request activates the login application; and transmits a login confirmation to the information system when the user affirms the confirmation request on the login application, wherein the information system grants the login request of the user when the information system receives the login confirmation from the verification server.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a flow chart of an embodiment of the present invention;

FIG. 3 is a flow chart of an embodiment of the present invention; and

FIG. 4A and 4B is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method of logging into information systems, such as web servers or websites. In particular, the present invention includes a system and method for logging into an information system by responding affirmatively to at least one of a text message, an email, a phone call and a notification on a custom software application of a smart device. Therefore, a user using the present invention does not need to use a password to login to the information system. Since user are encouraged to use complex passwords and are thereby subject to forget their passwords, the present invention solves this problem.

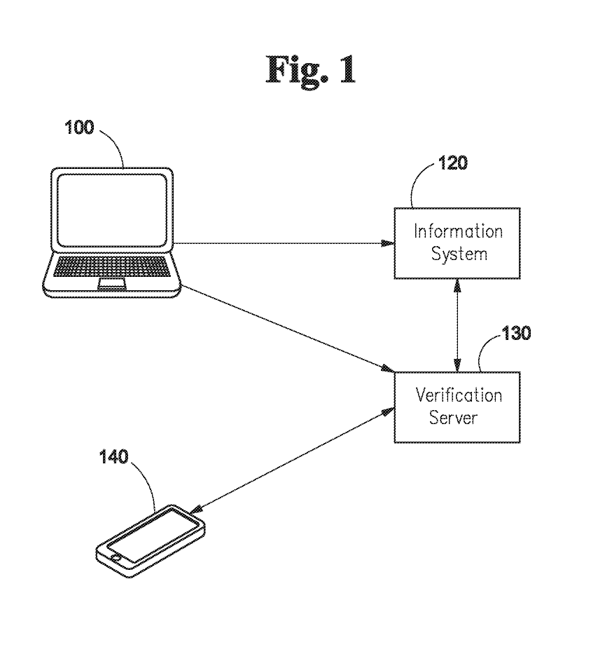

Referring now to FIG. 1, the present invention includes a system and method of logging into an information system 120 without the use of a password. The information system 120 first registers with a verification server 130. A user may then register with the verification server 130 and create a unique identifier. When the user attempts to sign into the information system 120, the user may submit their unique identifier to the information system 120 using a computer 100, such as a desktop or laptop. The information system 120 then transmits the unique identifier to the verification server 130 to authenticate the user. The verification server 130 then sends a confirmation request to the user to verify the user requested the login. For example, the confirmation request may be sent to a login application loaded on a smart device 140. The user may then send an affirmative message to the verification server 130 which in turn notifies the information system 120. The information system 120 then logs the user in without the use of a password.

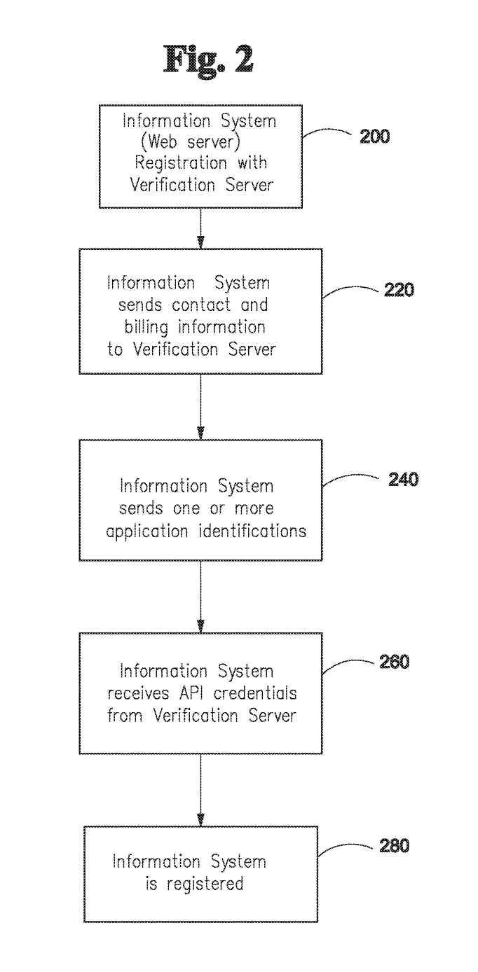

Referring to FIG. 2, the information system may include a web server hosting a website or a web server application loaded on a smart device. The information system first registers with the verification server 200 to utilize the verification server's services. The information system may provide their contact information and billing information to the verification server 220. The information system may receive API credentials from the verification server which authenticates the information system to the verification server 260. Each information system may register one or more applications (resources) to utilize with the verification server 240. Each application may be assigned its own Application Identification (ID), which may be part of the data submitted when accessing the verification server's API during the login process. The verified data submitted by the information system is saved on the memory of the verification server. The information system is then registered with the verification server 280.

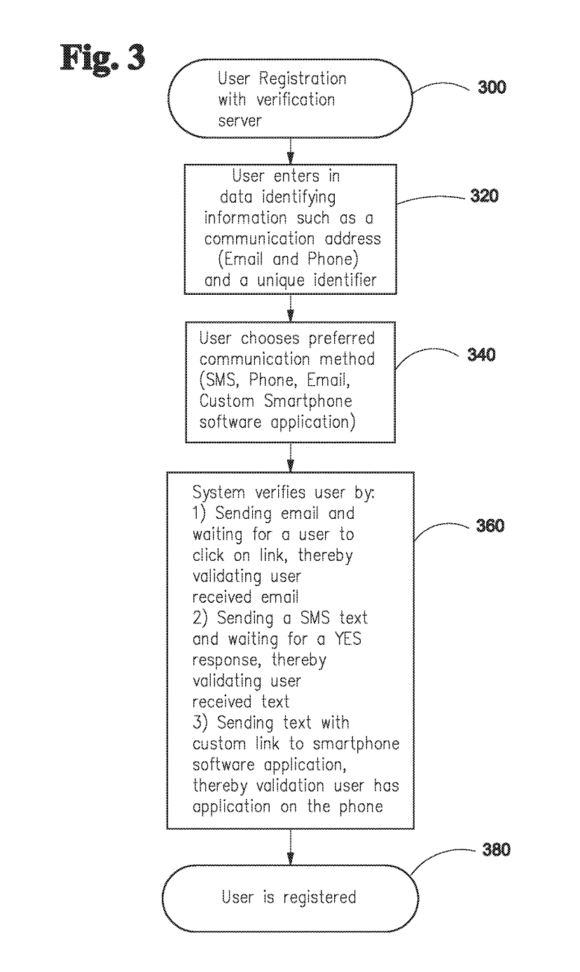

Referring to FIG. 3, a user then registers with the verification server 300. The user may enter user data to the verification server. The user data is identifying information including a unique identifier and a communication address 320. For example, the user data may include, but is not limited to, a name, an email address, a phone number, an address, a username, gender, date of birth and the like. The user may either create a unique identifier or use one of the above listed identifying information as the unique identifier. The user then selects their preferred type of communication, which includes, but is not limited to, text message, voice call, an email, a smart phone application and the like 340. The user may also select a secondary method of communication, described in further detail below. The verification server then verifies the user's email, phone number, and/or smart phone application by sending a message to the user's email, phone number, and/or smart phone application 360. The verified data submitted by the user is saved on the memory of the verification server. The user is then registered with the verification server 380.

The information system may include a public information system or a restricted information system. The public information system are systems in which the user may sign up for the public information system using the verification server account without any additional authorization required. Examples of public information systems include social media or public news feeds such as, but not limited to, Yahoo®, Linkedln®, Twitter®, Facebook®, Google® and the like. Restricted information systems are systems that may require an information system admin to explicitly grant access to a user outside of the the verification server. A restricted information system may include, but is not limited to, online financial systems, online customer relations management (CRM) systems, government systems and the like.

As mentioned above, the user enters user data to the verification server. Certain information systems may require different types of data from the user to login. For example, certain public information systems may only require an email address, while certain restricted information systems may require more personal information, such as a social security number, an address and the like. In such embodiments, the verification server allows users to enter the required data for each of the information systems. The verification server may further allow the user to choose which data is shared to which information system. For example, a social media web server may only require the user to share an email address. The user may select an option within the verification server in which the social media web server may only access the user's email from the verification server. The user may be required to share additional information, such as an address, to a banking web server. In such embodiments, the user may share the address with the banking web server without having to share their address with the social media web server.

In certain embodiments, the information system may register the user with the verification server. For example, the user may have a unique identifier for an account with the information system. The information system may provide an option for the user to sign up for the verification server's services. In such embodiments, the information system may transmit the user data directly to the verification server. The user data submitted by the information system is saved on the memory of the verification server and the user is then registered with the verification server.

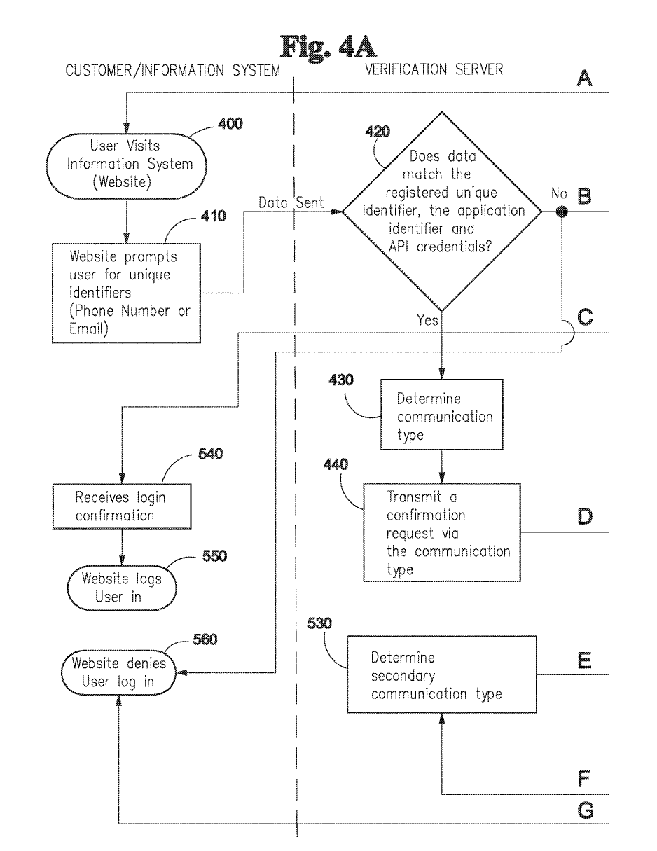

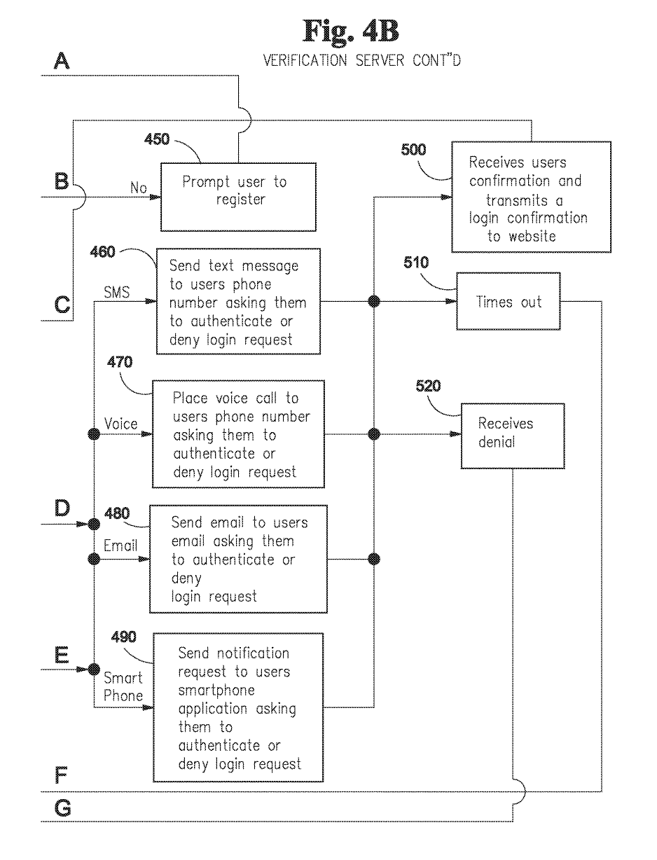

Referring to FIG. 4, after the above mentioned registrations have been completed, the user may sign into the information system without the use of a password. The user visits the information system, such as a website 400 with a login. The information system prompts the user to enter a unique identifier, such as, but not limited to, a cell phone, an email, or a created username that the user provided during registration 410. Once the user has entered their unique identifier, the user may select sign in to initiate a login request. The information system then sends the information system data and API credentials along with the unique identifier to the verification server. The processor of the verification server verifies the information system and that the user has registered with the verification server by comparing received data with the data stored on the verification server memory 420. If the user is not registered with the verification server, the user may be prompted to do so if the information system allows for user-initiated registration 450. The information system would then forward the user's registration data to the verification server. Otherwise, the information system may refer the user to register with the verification server and then contact the information system's customer support for access. In this case, the information system's customer support registers the user as a valid user on the verification server once the user has completed registration with the verification server.

If the received data does not match the data stored on the verification server memory, the information system denies the user login 560. If the received data does match the data stored on the verification server memory, the processor of the verification server determines the communication method the user had previously chosen 430. The verification server then transmits a confirmation request via the communication type 440. For example, the verification system may send a text message to the user's phone number 460, place a voice call to the user's phone number 470, send an email to the user's email 480, and send a notification request to the user's smart phone application 490. Each of the above messages sent is a confirmation request for the user to affirm the login request of the information system.

If the user affirms the login request, the processor of the verification server receives the user's confirmation and transmits a login confirmation to the information system 500. The information system receives the login confirmation 540 from the verification server and the website logs the user in 550 without the use of a password.

As mentioned above, the user data may further include at least one secondary communication address. If the user fails to affirm the confirmation request on the initial type of communication within a set period of time (times out) 510, the processor of the verification server determines the secondary communication method 530 and transmits the confirmation request to the secondary communication type and/or address. If the user fails to respond to the secondary communication within the time frame (times out) 510 or if the user sends a denial 520 for the login request, the information system denies the user login 560.

In certain embodiments, the present invention may utilize a login application loaded on a remote computer. The remote computer may be a smart device, such as a smart phone or tablet. In such embodiments, the verification server transmits a confirmation request to the remote computer of the user to confirm the login request. The confirmation request may automatically activate the login application. Activating the application may include either launching the login application on the smart device or providing a notification on the smart device for the user to launch the login application. The confirmation request may be displayed on the smart device screen in the form of a “Yes” and “No” button. The user may select the “Yes” button to affirm the confirmation request and the user may select “No” to deny the confirmation request. In certain embodiments, the user may affirm the confirmation request by a biometrics authorization. The login application may utilize the biometric authorization capability of the remote computer. The biometrics authentication may include, but is not limited to, a fingerprint recognition, a facial recognition, a heartbeat recognition, a voice recognition, and an iris recognition. For example, the login application may open and prompt the user to use their fingerprint for the biometrics authentication. The user may press their thumb against a fingerprint reader. If the fingerprint of the user matches with an authorized fingerprint of the remote computer, the login application may automatically transmit a login confirmation to the information system. The user is then logged into the information system without the use of a password.

In certain embodiments, the present invention may utilize a symbol for additional authentication. For example, if the user is confirmed to be registered with the verification server, the information system generates a first verification symbol. The verification symbol may be a number, a plurality of numbers forming a code, an image, and the like. The information system then displays the first verification symbol to the user on the website of the information system. The information system then transmits the first verification symbol to the verification server. The verification server determines the communication type the user had previously chosen. The verification server then transmits a second verification symbol to the user via the verification type which prompts the user to confirm a login request by comparing the first verification symbol and the second verification symbol to ensure that the login request was indeed initiated by the user.

The verification server may send the user the second verification symbol with the confirmation request to the user's phone via text message. In such embodiments, the user receives a text message. The text message may include a message briefly describing the requested service, the name of the verification server and the second verification symbol. The verification symbol may be in the form of a code, such as a series of numbers. The user is prompted to confirm that the second verification symbol in the text message matches the first verification symbol displayed by the information system. If the verification symbols match, the user may send an affirmative text message, such as “Yes” or “Confirm”, to the verification server. If the verification symbols do not match, or if the user receiving the message never requested a login, the user may send a negative message, such as “No” or “Deny”. If the verification server receives an affirmative message from the user, the verification server notifies the information system that the verification server and the user have validated the user's login request. The user is then logged into the information system without the use of a password.

The verification server may send the second verification symbol with the confirmation request by dialing the user's phone number. The phone call may include a message briefly describing the requested service, the name of the verification server and the second verification symbol. The verification symbol may be in the form of a code, such as a series of numbers. The user is prompted to confirm that the second verification symbol matches the first verification symbol displayed by the information system. If the verification symbols match, the user may select certain numbers on the phone to confirm or say an affirmative message, such as “Yes” or “Confirm”. If the verification symbols do not match, or if the user receiving the message never requested a login, the user may select certain numbers on the phone to deny or say a negative message, such as “No” or “Deny”. The message is sent to the verification server. If the verification server receives an affirmative message from the user, the verification server notifies the information system that the verification server and the user have validated the user's login request. The user is then logged into the information system without the use of a password.

The verification server may send the second verification symbol with the confirmation request to the user's email. The email may include a message briefly describing the requested service, the name of the verification server, the second verification symbol and two separate embedded links presented as an affirmation link and a denial link. The verification symbol may be in the form of an image. The user is prompted to confirm that the second verification symbol matches the first verification symbol displayed by the information system. If the verification symbols match, the user may either select the affirmation link or reply via email with an affirmative message, such as “Yes” or “Confirm”, and thereby send the affirmative message to the verification server. If the verification symbols do not match, or if the user receiving the message never requested a login, the user may either select the denial link or reply via email with a negative message, such as “No” or “Deny”, and thereby send the negative message to the verification server. If the verification server receives the affirmative message from the user, the verification server notifies the information system that the verification server and the user have validated the user's login request. The user is then logged into the information system without the use of a password.

The verification server may send the second verification symbol with the confirmation request to the login application. The user may be notified to open the login application or the login application may automatically open and present information including a message briefly describing the requested service, the name of the verification server and the second verification symbol. The verification symbol may be in the form of an image. The user is prompted to confirm that the second verification symbol in the application matches the first verification symbol displayed by the information system. If the verification symbols match, the user may select an affirmative message presented by the application, such as “Yes” or “Confirm”. If the verification symbols do not match, or if the user receiving the message never requested a login, the user may select a negative message, such as “No” or “Deny”. The message is sent to the verification server. If the verification server receives an affirmative message from the user, the verification server notifies the information system that the verification server and the user have validated the user's login request. The user is then logged into the information system using their fingerprint without the use of a password.

In certain embodiments, the login application may display a list of the information systems that the user can log into using the verification server. The login application may further display which information systems that the user is currently logged into. The login application may further include a logout button displayed adjacent to the information system that the user is currently logged into. Therefore, the user may select the logout button and logout of the information system. When the user selects the logout button, a logout request is transmitted from the remote computer to the verification server and the verification server may transmit the logout request to the information system. The information system may then logout the user.

In certain embodiments, the remote computer includes a global positioning system (GPS) that sends coordinates of the remote computer to the verification server. The user may be given an option to set a location range when the user registers with the verification server. In such embodiments, when the user attempts the login request with the information system, the location of the remote computer is sent to the verification server. The location of the remote computer may be determined by the coordinates sent by the GPS or by the IP address of the remote computer. If the location of the remote computer is outside of the location range, the verification server denies the login request of the user.

In certain embodiments, the GPS of the remote computer may periodically send coordinates of the remote computer to the verification server. Therefore, the verification server is constantly updating the location of the remote computer. In such embodiments, the user may be automatically signed out of the information system once the remote computer moves outside of the location range.

In certain embodiments, a user may set certain login requests to require confirmation from other users. For example, a user may have joint accounts in which more than one user must confirm prior to accessing the account. Further, a user may only want to access certain accounts if another user can confirm for security purposes. In such embodiments, a confirmation request is sent to multiple users. Each user must confirm the login request prior to the verification server transmitting the login confirmation to the information system. Therefore, if only one user affirms the confirmation request, the login confirmation is not sent to the information system, and information system denies the login request. The user may be given an option to set how many confirmation requests are needed for each account and to whom during the user registration with the verification server.

The present invention may further utilize alternative safety protocols to prevent unauthorized users from logging into user accounts. For example, the remote computer may be collecting data of the user with regard to the user's routine. If the user attempts to login during a period in which the user is outside of the routine, the verification server may deny the login request. Further, the present invention may incorporate a distress signal, in which the user sends the distress signal if the user is being forced to log into an account against their will. For example, the user may register a right thumb print as the affirmation of the login request and may register a left thumb print as a distress signal. Therefore, if the user uses their right thumb for the finger print reader, the user is then logged into the information system. If the user uses their left thumb for the finger print reader, a distress signal is sent to the verification server and the verification server may notify the authorities. Further, the confirmation request may provide a selection to send the distress signal using alternative communication types.

It should be understood, of course, that the foregoing relates to exemplary embodiments of the invention and that modifications may be made without departing from the spirit and scope of the invention as set forth in the following claims.

What is claimed is:

1. A method of logging into an information system, the steps comprising:
receiving information system data at a verification server from the information system, wherein the verification server comprises a processor and a memory that stores the information system data;
receiving user data at the verification server, the user data comprising at least a unique identifier and a communication address, wherein the memory stores the user data; and
receiving a login request at the information system from the user by the user submitting the unique identifier to the information system, wherein the information system transmits the information system data and the unique identifier submitted by the user to the verification server,
wherein the processor of the verification server
compares the information system data and the unique identifier sent from the information system with the information system data and the unique data stored on the memory,
transmits a confirmation request to the communication address of the user to confirm the login request if the unique identifier and the information system data sent from the information system matches the unique identifier and the information system data stored on the memory, and
transmits a login confirmation to the information system when the user affirms the confirmation request,
wherein the information system grants the login request to the user when the information system receives the login confirmation from the verification server.

2. The method of claim 1, further comprising the step of:
receiving an authentication credential at the information system from the verification server when the verification server receives the information system data, wherein
the information system transmits the authentication credential to the verification server with the unique identifier and the information system data after the login request is performed, and
the processor of the verification server authenticates the information system via the authentication credential.

3. The method of claim 2, wherein the authentication credential is an application programming interface credential.

4. The method of claim 1, wherein the communication address comprises at least one of a telephone number and an email address.

5. The method of claim 4, wherein the user data further comprises a selection of a type of communication for the communication address, wherein the type of communication comprises at least one of a telephone call, a text message, and an email.

6. The method of claim 1, further comprising the step of:
providing a login application to a user for installing on a remote computer, wherein
the communication address is of the remote computer,
the confirmation request activates the login application on the remote computer, and
the processor transmits the login confirmation to the information system when the user affirms the confirmation request on the login application.

7. The method of claim 6, wherein the login application accesses a biometrics authentication of the remote computer, wherein the user affirms the confirmation request on the login application by performing the biometrics authentication.

8. The method of claim 7, wherein the biometrics authentication comprises at least one of a fingerprint recognition, a facial recognition, a heartbeat recognition, a voice recognition, and an iris recognition.

9. The method of claim 1, wherein the information system is a web server hosting a web site or a web server application loaded on the remote computer.

10. A method of logging into an information system, the steps comprising:
providing a login application to a user for installing on a remote computer;
receiving information system data at a verification server from the information system, wherein the verification server comprises a processor and a memory that stores the information system data;
receiving user data at the verification server, the user data comprising at least a unique identifier and a communication address of the remote computer, wherein the memory stores the user data; and
receiving a login request at the information system from the user by the user submitting the unique identifier to the information system, wherein the information system transmits the information system data and the unique identifier of the user to the verification server,
wherein the processor of the verification server
compares the unique identifier and the information system data sent from the information system with the unique identifier and the information system data stored in the memory,
transmits a confirmation request to the remote computer of the user to confirm the login request if the unique identifier and the information system data sent from the information system matches the unique identifier and the information system data stored in the memory, wherein the confirmation request activates the login application; and
transmits a login confirmation to the information system when the user affirms the confirmation request on the login application,
wherein the information system grants the login request of the user when the information system receives the login confirmation from the verification server.

11. The method of claim 10, further comprising the step of:
receiving an authentication credential at the information system from the verification server when the verification server receives the information system data, wherein
the information system transmits the authentication credential to the verification server with the unique identifier and the information system data after the login request is performed, and
the processor of the verification server authenticates the information system via the authentication credential.

12. The method of claim 11, wherein the authentication credential is an application programming interface credential.

13. The method of claim 10, wherein the remote computer further comprises a global positioning system periodically transmitting coordinates of the remote computer to the verification server.

14. The method of claim 13, wherein the user data further comprises a location range of the remote computer, wherein the processor of the verification server denies the login request if the remote computer is outside of the location range.

15. The method of claim 10, wherein the remote computer transmits a logout request to the information system when the user selects a logout button displayed within the login application.

16. The method of claim 10, wherein the user data further comprises at least one secondary communication address, wherein the processor of the verification server transmits the confirmation request to the secondary communication address if the user fails to affirm the confirmation request on the login application within a set time period.

17. The method of claim 16, wherein the secondary communication address comprises at least one of a telephone number and an email address.

18. The method of claim 10, wherein the login application accesses a biometrics authentication of the remote computer, wherein the user affirms the confirmation request on the login application by performing the biometrics authentication.

19. The method of claim 18, wherein the biometrics authentication comprises at least one of a fingerprint recognition, a facial recognition, a heartbeat recognition, a voice recognition, and an iris recognition.

20. The method of claim 10, wherein the information system is a web server hosting a web site or a web server application loaded on the remote computer.
